(19) United States
(12) Patent Application Publication
(10) Pub. No.: US 2011/0166803 A1
(43) Pub. Date: Jul. 7, 2011

(54) METHOD FOR DETERMINING AN OVER-PRESSURE IN A FUEL STORAGE MEANS OF AN INJECTION SYSTEM OF AN INTERNAL COMBUSTION ENGINE

(76) Inventors: Stefan Koidl, Stuttgart (DE); Matthias Siedentopf, Heimsheim (DE); Stefan Keller, Stuttgart (DE); Christian Kuhnert, Vaihingen/Enz (DE); Detlev Straub, Stuttgart (DE)

(21) Appl. No.: 12/989,908

(22) PCT Filed: Dec. 18, 2008
(86) PCT No.: PCT/EP2008/067912

§ 371 Date: Dec. 30, 2010

(30) Foreign Application Priority Data
Apr. 29, 2008 (DE) 102008001444.3

(51) Int. Cl. G01M 15/04; G06F 19/00

(52) U.S. Cl. 702/50; 73/114.51

(57) ABSTRACT

A method for determining an overpressure in a fuel reservoir of an injection system of an internal combustion engine, in particular in a common rail of a common rail system, the pressure in the fuel reservoir being sensed, an overpressure in the fuel reservoir being identified if the derivative of the sensed pressure over time exceeds a predetermined slope threshold value and the sensed pressure then exceeds a predetermined pressure threshold value.

### FIELD OF THE INVENTION

The present invention relates to a method for determining an overpressure in a fuel reservoir of an injection system of an internal combustion engine, to a corresponding computer program, and to a corresponding computer program product.

### BACKGROUND INFORMATION

Common rail systems (CRS) are widely used at present for fuel injection in diesel engines. A common rail system is explained with reference to FIG. 1. FIG. 1 shows an injection system 100 for an internal combustion engine such as the system on which the present invention is based. Injection system 100 encompasses a fuel tank 110 from which fuel is delivered, by way of an electrical fuel pump 120 (EFP), to a metering unit (FMU) 130. Metering unit 130, in reaction to a control signal z of a control unit 180, makes a specific quantity of fuel available for a downstream high-pressure pump 140. High-pressure pump 140 pumps the fuel into a fuel reservoir (common rail) 150, in which the fuel is stored under high pressure in order to be available upon request for injection valves (injectors) 160. Fuel reservoir 150 is equipped with a pressure sensor 170 (rail pressure sensor, RPS) that serves to determine the pressure in the fuel reservoir. Pressure sensor 170 conveys the measured pressure in fuel reservoir 150, in the form of a measurement signal p, to control unit 180 of injection system 100. The measurement signal can be embodied in digital or analog fashion.

Conventional (rail) pressure sensors furnish at the output a measurement signal that is proportional to the measured (rail) pressure. Conventional practice is to use pressure sensors that output a maximum measurement signal which correspond to a pressure value that is approx. 200 bar above the usual operating pressure of an injection system. It is thus not possible for the connected control unit to determine pressures above the maximum pressure value that can be outputted. The control unit has therefore not hitherto been capable of detecting overpressures, or harmful pressures, quickly enough. Additional elements such as, for example, pressure limiting valves are used for this reason in known injection systems in order to avoid harmful pressures in the fuel reservoir.

A variety of possibilities are known for regulating the pressure in the fuel reservoir or limiting it to harmless levels. For example, the high-pressure pump or the fuel reservoir can be equipped with a pressure regulating valve (DRV) that returns an excess delivered quantity back to the fuel container.

It is also understood, in order to reduce the costs of an injection system, to configure so-called adjuster systems, in which the pressure in the fuel reservoir is adjusted only by way of the metering, unit; this makes it possible to dispense with the cost-intensive pressure regulating valve. In order to limit the rail pressure in the event of a fault, however, for example if a defect exists in the metering unit or it remains in an open state (FMU stuck open), it usual to utilize injectors that open in the event a pressure threshold value (e.g. 2500 bar) is exceeded, and allow the pressure to be dissipated by leakage.

Injectors that do not have this kind of overpressure functionality, or in which leakage occurs only at pressures that are already harmful to the system, are also used, however. When such injectors are utilized it is therefore usual to equip the fuel reservoir with a pressure limiting valve (PLV) that, when a pressure threshold value is exceeded, opens and dissipates the pressure in the fuel reservoir. This action has the disadvantage, however, that the injection system must be equipped with an additional pressure limiting valve.

### SUMMARY OF THE INVENTION

The exemplary embodiments and/or exemplary methods of the present invention therefore provides a method for determining an overpressure in a fuel reservoir of an injection system of an internal combustion engine, in particular of a common rail system; a corresponding computer program; and a corresponding computer program product, having the features of the independent claims, which do not exhibit these disadvantages. Advantageous refinements are the subject matter of the dependent claims and of the description below.

With the approach according to the exemplary embodiments and/or exemplary methods of the present invention, conventional pressure sensors are used to determine an overpressure in a fuel reservoir and as a consequence to initiate pressure reduction actions, with no need to provide additional, in particular cost-intensive, components. The exemplary embodiments and/or exemplary methods of the present invention offers the possibility of reliably operating an injection system, in particular a common rail system as depicted e.g. in FIG. 1, and of quickly and reliably detecting an overpressure, without needing to use, for example, a pressure regulating valve or a pressure limiting valve. It is possible to determine an undesired overpressure in injection systems that are equipped with a pressure sensor whose maximum outputtable signal value does not itself, in particular, yet correspond to an undesired overpressure. In particular, a pressure threshold value used in the context of the method according to the exemplary embodiments and/or exemplary methods of the present invention is such that merely exceeding it does not yet represent an overpressure. It is thus possible to use pressure sensors that encompass a limited measurement range.

Advantageously, an overpressure in the fuel reservoir is identified only if the sensed pressure exceeds the predetermined pressure threshold value within a predetermined first time span after the derivative of the sensed pressure over time last exceeded the predetermined slope threshold value. The predetermined first time span can be zero, or arbitrarily short. For example, an overpressure is thus identified if the slope threshold value remains exceeded until the pressure threshold value is exceeded. A time interval can likewise be provided as being harmless for detection of an overpressure. An overpressure can therefore also be identified if the slope falls below the threshold value for a short time (corresponding to the first time span) before the pressure threshold value is exceeded.

Usefully, an overpressure in the fuel reservoir is identified only if the sensed pressure exceeds the predetermined pressure threshold value for longer than a predetermined second time span. An exceedance of the pressure threshold value that is brief (corresponding to the second time span), and thus harmless, can thus be accepted without identifying an overpressure.

It is advantageous if an overpressure in the fuel reservoir is identified only if the derivative of the sensed pressure over time exceeds the predetermined slope threshold value for longer than a predetermined third time span.

The first, second, and third time spans can be selected independently of one another, so that an advantageous combination of time spans can be made available for the particular injection system to be dealt with. An advantageous value for the second time span is, for example, 10 ms. The pressure threshold value must therefore be exceeded for at least 10 ms in order to identify an overpressure. Using the parameters described (time spans and threshold values), the method can be optimally matched to different injection systems.

It is particularly advantageous if a fuel pump that makes fuel available to a metering unit, and/or a high-pressure pump that pumps fuel into the fuel reservoir, are shut off when an overpressure is identified. The probability of harm to the injection system can thereby be decreased.

According to an exemplary embodiment of the present invention, fuel is discharged out of the fuel reservoir when an overpressure is identified. This can be accomplished, in a manner not affecting torque, through the injectors, as also discussed in DE 196 36 397 A1. The probability of harm to the injection system can thereby be further decreased.

It is useful to provide a fault count value that is incremented, which may be by one, when an overpressure is identified. For example, a metering unit is not defective at the first occurrence of an overpressure. A fault count threshold value, for example, can be provided, such that when it is exceeded, a defect is identified. The possibility further exists of providing for component replacement after a defined number of fault events.

The exemplary embodiments and/or exemplary methods of the present invention further relates to a control unit for a motor vehicle that is designed to execute a method according to the present invention.

The exemplary embodiments and/or exemplary methods of the present invention further relates to a computer program having a program code arrangement which are suitable for executing a method according to the present invention when the computer program is executed on a computer or on a corresponding calculation unit, in particular on a control unit according to the present invention.

The computer program product provided according to the present invention encompasses a program code arrangement, stored on a computer-readable data medium, which are suitable for executing a method according to the present invention when the computer program is executed on a computer or on a corresponding calculation unit, in particular on a control unit according to the present invention. Suitable data media are, in particular, diskettes, hard drives, flash memories, EEPROMs, CD-ROMs, DVDs, and many more. Downloading of a program via computer networks (Internet, intranet, etc.) is also possible.

Further advantages and embodiments of the exemplary embodiments and/or exemplary methods of the present invention may be gathered from the description and the attached drawings.

It is understood that the features recited above and those yet to be explained below can be used not only in the respective combination indicated, but also in other combinations or in isolation, without leaving the context of the exemplary embodiments and/or exemplary methods of the present invention.

### BRIEF DESCRIPTION OF THE DRAWINGS

FIG. 1 schematically depicts an injection system for an internal combustion engine.

FIG. 2 schematically shows a measured rail pressure correlated with time.

FIG. 3 schematically shows both a rail pressure and a low pressure correlated with time.

FIG. 4 schematically shows a rail pressure, a low pressure, and an injection quantity correlated with time.

### DETAILED DESCRIPTION

The exemplary embodiments and/or exemplary methods of the present invention is schematically depicted in the drawings on the basis of an exemplifying embodiment, and will be described in detail below with reference to the drawings.

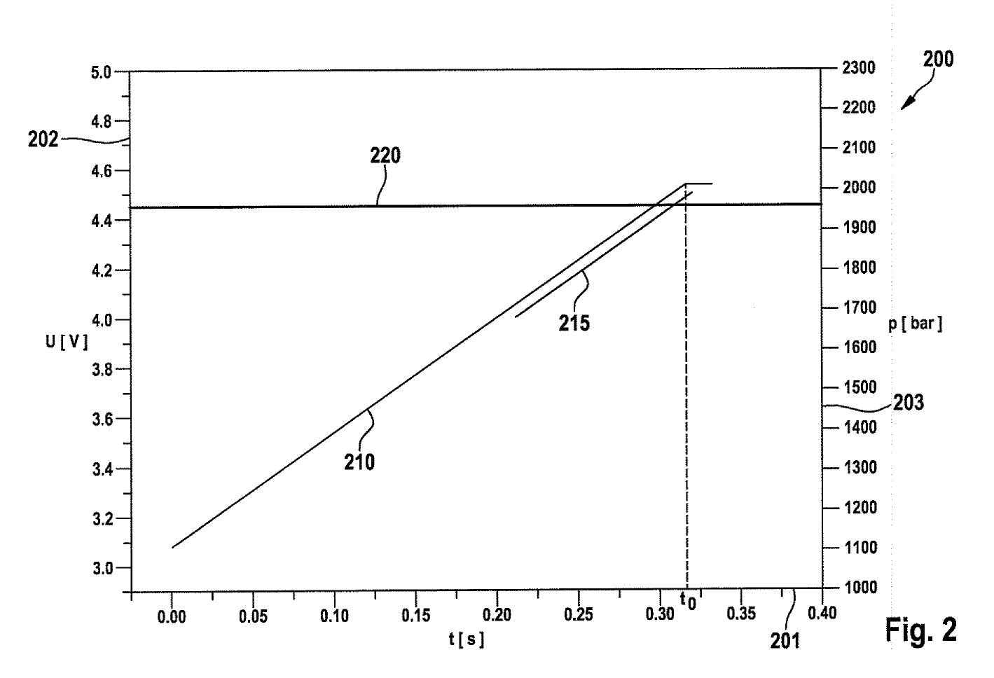

FIG. 2 schematically depicts, in a diagram 200, the curve of a measurement signal 210 of a measured rail pressure with respect to time. The measurement signal is plotted in diagram 200 as voltage value U on a first Y axis 202, against time t on an X axis 201. Depicted on a second Y axis 203 is a pressure value p that corresponds to the outputted voltage value. It is understood that a sensor can likewise output a digital measurement signal that represents the pressure value. Measurement signal 210 for the rail pressure rises over time until it transitions into saturation at a time t0. The maximum measurement signal value that can be outputted with the rail pressure sensor selected as an example is thus reached at time to. This measurement signal value corresponds, in the example shown, to a rail pressure value of approx. 2000 bar.

A pressure harmful to the system has not yet been reached, however, when this rail pressure is reached. The pressure limiting valves recited in the introduction to the specification are designed, for example, for pressures of approx. 2500 bar. The method according to the present invention now makes it possible to distinguish between harmful and harmless pressures, as described below.

In the embodiment depicted, an overpressure, i.e. in particular a harmful pressure, is identified when the time-dependent signal curve 210 firstly exceeds a predetermined slope value. This predetermined slope value is depicted schematically in diagram 200 as straight line 210. It is additionally necessary for signal curve 210, after exceeding slope value 210 (immediately or with a time delay, depending on the embodiment), to exceed a threshold signal value 220.

A short circuit or other defect in the sensor usually furnishes a signal value that is well below the maximum signal value that can be outputted under operating conditions. In the illustration shown, an output value in the event of a sensor defect could be, for example 5V.

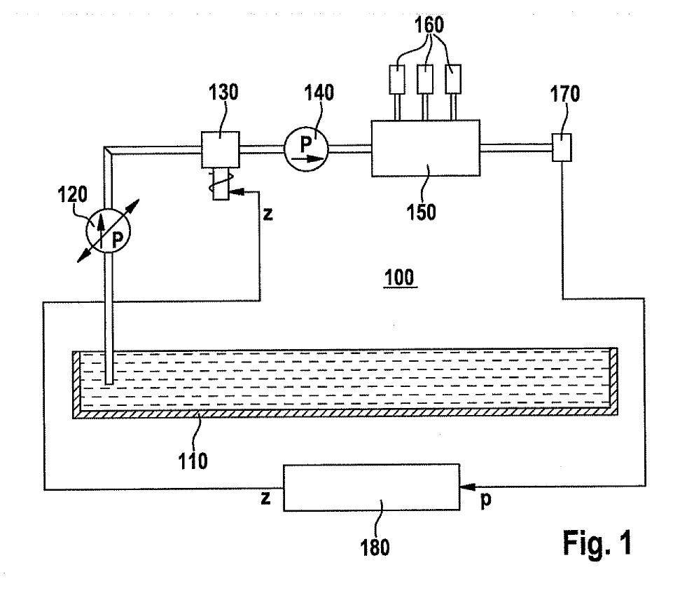

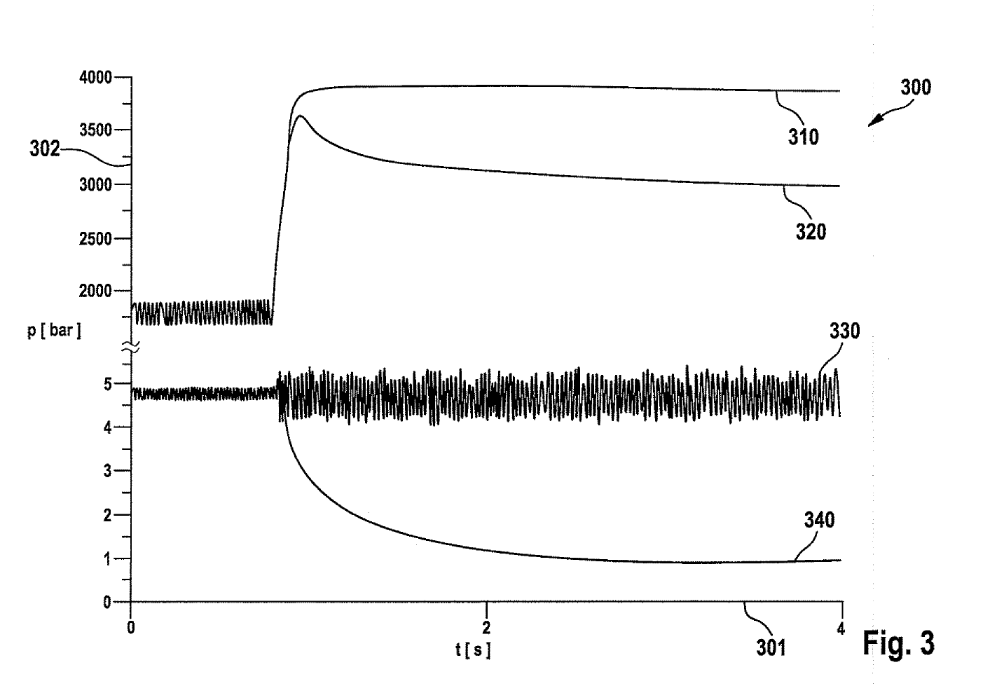

FIG. 3 illustrates, in a diagram 300, time-dependent pressure curves 310, 320, 330 and 340. The pressure curves are depicted as pressure values p on a Y axis 302, against time t on an X axis 301. Pressure curve 310 corresponds to a rail pressure curve in the event of a fault in which, in an adjuster system described above, the metering unit remains in an open state. It is evident that rail pressure curve 310 possesses, for an extended time, a value of approx. 3800 bar, which usually results in damage to the injection system. A further pressure curve 330 shows the associated pressure curve in the low-pressure region, i.e. for example in the region upstream from high-pressure pump 340 according to FIG. 1.

Rail pressure curve 320, on the other hand, corresponds to a pressure curve in which, utilizing the method according to the present invention, the overpressure is detected and electrical fuel pump 120 is then advantageously shut off. It is evident that rail pressure curve 320, after a maximum at approx. 3600 bar, decreases again and approaches a value of approx. 3000 bar. The probability of harm to the injection system can thereby already be decreased. Low-pressure curve 340 is associated with rail pressure curve 320.

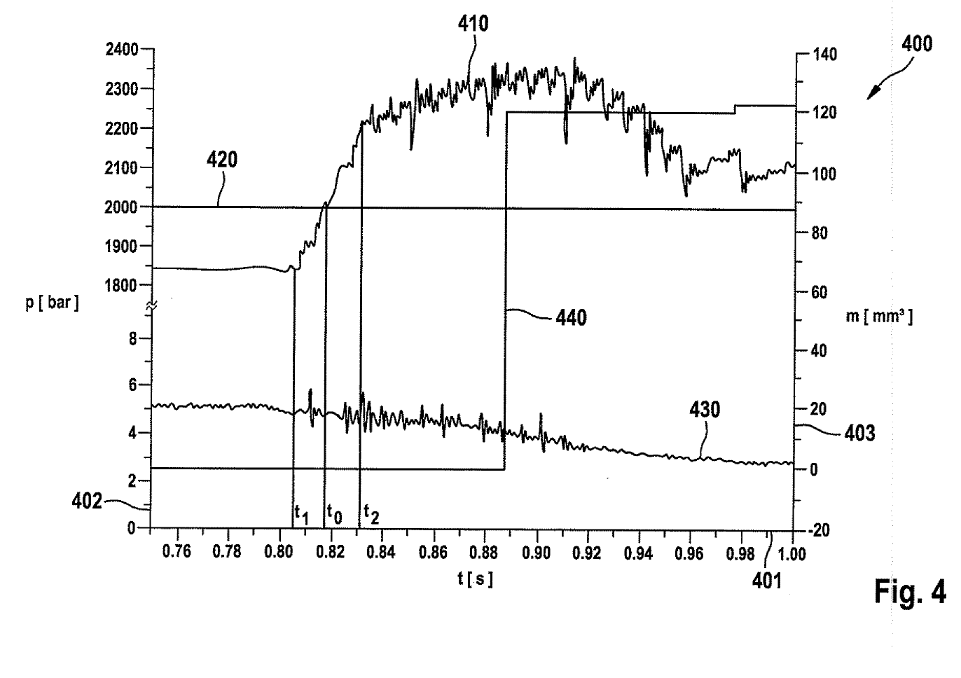

To improve pressure dissipation when an overpressure is identified, the pressure in the fuel reservoir can be additionally dissipated, using the method according to the present invention, through injectors 160. A corresponding pressure curve is illustrated in FIG. 4.

FIG. 4 depicts, in a diagram 400, time-dependent pressure curves 410, 430 and a time-dependent injection quantity curve 440. The pressure curves are plotted as pressure values p on a first Y axis 402, against time t on an X axis 401. Injection quantity curve 440 is plotted as injection quantity m on a second Y axis 403, against time t on X axis 401.

FIG. 4 depicts a rail pressure curve 410 when non-torque-effective injections (emergency injections) are activated as an additional action. It may be useful in this context, instead of a large injection quantity per injector and per cycle, to inject multiple small quantities per injector, in order to have more control opportunities down to low pressure. Along with simultaneous shutoff of the fuel pump, this ensures that the rail pressure does not rise above a permissible value. Shutoff of the fuel pump serves to limit the injection quantity necessary for pressure dissipation. Low-pressure curve 430 is associated with rail pressure curve 410.

Rail pressure curve 410 initially has a value of approx. 1850 bar. At a time t1 located at approximately 0.81 s, a fault occurs in the metering unit of the injection system so that the metering unit remains in an open state. The rail pressure consequently rises sharply until, at a time to, it exceeds a threshold value 420. In addition, the slope of the rail pressure curve between times t1 and t0 is above a predetermined slope threshold value. The method used in FIG. 4 may be configured so that an overpressure is detected when, after the predetermined slope threshold value has been exceeded, the predetermined pressure threshold value is exceeded for longer than a predetermined time span. In FIG. 4 this time span corresponds to the interval t0-t2 between times t0 and t2. Because rail pressure curve 410 has thus continued to exceed the predetermined pressure threshold value 420 after time t2 is reached, an overpressure is identified. The consequence of having identified the overpressure, as already described with reference to FIG. 3, is that the fuel pump is shut off. To improve pressure dissipation, a non-torque-effective injection is additionally carried out, as is evident with reference to injection quantity curve 440. It is evident that as compared with FIG. 3, under the same boundary conditions, the rail pressure can be limited to below 2400 bar.

To prevent uncombusted fuel, in particular diesel, from being conveyed back to the combustion chamber and combusted after having been ejected therefrom, an exhaust gas recirculation (EGR) value that is present should be closed. To inhibit combustion of the ejected fuel, it is useful to reduce the quantity of oxygen in the exhaust gas. For this, the throttle should be closed to the greatest extent possible. Care should be taken in this context that, depending on the operating point of the engine, an appreciable vacuum can occur in the air system. If the throttle valve is completely closed, the result can be destruction of the air intake section and therefore uncontrolled air intake; this must therefore be avoided.

The method according to the present invention allows a harmful overpressure in an injection system of an internal combustion engine to be detected quickly and, consequently, also may be quickly dissipated.

It is understood that the Figures depicted illustrate only a exemplary embodiment of the present invention. Any other embodiment in addition thereto is also conceivable without departing from the scope of this invention.

1-10. (canceled)

11. A method for determining an overpressure in a fuel reservoir of a common rail injection system of an internal combustion engine, the method comprising:
sensing the pressure in the fuel reservoir; and
identifying an overpressure in the fuel reservoir if the derivative of the sensed pressure over time exceeds a predetermined slope threshold value and the sensed pressure then exceeds a predetermined pressure threshold value.

12. The method of claim 11, wherein an overpressure in the fuel reservoir is identified only if the sensed pressure exceeds the predetermined pressure threshold value within a predetermined first time span after the derivative of the sensed pressure over the time last exceeded the predetermined slope threshold value.

13. The method of claim 11, wherein an overpressure in the fuel reservoir is identified only if the sensed pressure exceeds the predetermined pressure threshold value for longer than a predetermined second time span.

14. The method of claim 11, wherein an overpressure in the fuel reservoir is identified only if the derivative of the sensed pressure over time exceeds the predetermined slope threshold value for longer than a predetermined third time span.

15. The method of claim 11, wherein at least one of a fuel pump, which makes fuel available to a metering unit, and a high-pressure pump, which pumps fuel into the fuel reservoir, is shut off when an overpressure is identified.

16. The method of claim 11, wherein fuel is discharged out of the fuel reservoir when an overpressure is identified.

17. The method of claim 11, wherein a fault count value is provided that is incremented when an overpressure is identified.

18. A control unit for determining an overpressure in a fuel reservoir of a common rail injection system of an internal combustion engine, comprising:
a sensing arrangement to sense the pressure in the fuel reservoir; and
an identifying arrangement to identify an overpressure in the fuel reservoir if the derivative of the sensed pressure over time exceeds a predetermined slope threshold value and the sensed pressure then exceeds a predetermined pressure threshold value.

19. A computer readable medium having a computer program, which is executable by a processor, comprising:
a program code arrangement having program code for determining an overpressure in a fuel reservoir of a common rail injection system of an internal combustion engine, by performing the following:
sensing the pressure in the fuel reservoir; and
identifying an overpressure in the fuel reservoir if the derivative of the sensed pressure over time exceeds a predetermined slope threshold value and the sensed pressure then exceeds a predetermined pressure threshold value.

20. The computer readable medium of claim 19, wherein an overpressure in the fuel reservoir is identified only if the sensed pressure exceeds the predetermined pressure threshold value within a predetermined first time span after the derivative of the sensed pressure over the time last exceeded the predetermined slope threshold value.

21. The computer readable medium of claim 19, wherein an overpressure in the fuel reservoir is identified only if the sensed pressure exceeds the predetermined pressure threshold value for longer than a predetermined second time span.

22. The computer readable medium of claim 19, wherein an overpressure in the fuel reservoir is identified only if the derivative of the sensed pressure over time exceeds the predetermined slope threshold value for longer than a predetermined third time span.

23. The computer readable medium of claim 19, wherein at least one of a fuel pump, which makes fuel available to a metering unit, and a high-pressure pump, which pumps fuel into the fuel reservoir, is shut off when an overpressure is identified.

24. The computer readable medium of claim 19, wherein fuel is discharged out of the fuel reservoir when an overpressure is identified.

25. The computer readable medium of claim 19, wherein a fault count value is provided that is incremented when an overpressure is identified.
